(19) United States
(12) Patent Application Publication
(10) Pub. No.: US 2009/0252118 A1
(43) Pub. Date: Oct. 8, 2009

(54) HANDOFF BETWEEN PACKET-SWITCHED NETWORK AND CIRCUIT-SWITCHED NETWORK

(75) Inventors: John Wallace Nasielski, San Diego, CA (US); Mahesh A. Makhijani, San Diego, CA (US); Arungundram C. Mahendran, San Diego, CA (US); Haipeng Jin, San Diego, CA (US)

Correspondence Address: QUALCOMM INCORPORATED, 5775 MOREHOUSE DR., SAN DIEGO, CA, 92121, US

(73) Assignee: QUALCOMM Incorporated, San Diego, CA (US)

(21) Appl. No.: 12/416,196

(22) Filed: Apr. 1, 2009

Related U.S. Application Data
(60) Provisional application No. 61/042,539, filed on Apr. 4, 2008.

(51) Int. Cl. H04W 36/00; H04L 12/66

(52) U.S. Cl. 370/331; 455/436; 370/352

(57) ABSTRACT

Techniques for supporting handoff of terminals between a packet-switched network and a circuit-switched network are described. In an aspect, handoff between packet-switched and circuit-switched networks may be facilitated by a designated network entity in the packet-switched network. The designated network entity may interface with both the packet-switched network and the circuit-switched network, perform circuit-switched call origination, and perform handoff procedure. In one design, a first terminal may communicate with the packet-switched network for a packet-switched call with a second terminal. The first terminal may initiate handoff to the circuit-switched network via the designated network entity. The first terminal may perform handoff from the packet-switched network to the circuit-switched network based on an inter-MSC handoff procedure. The first terminal may then communicate with the circuit-switched network for the circuit-switched call with the second terminal after the handoff.

The present application claims priority to provisional U.S. Application Ser. No. 61/042,539, entitled “METHOD AND APPARATUS FOR INTER-SYSTEM HANDOFF IN WIRELESS COMMUNICATIONS,” filed Apr. 4, 2008, assigned to the assignee hereof and incorporated herein by reference.

### BACKGROUND

I. Field

The present disclosure relates generally to communication, and more specifically to techniques for performing handoff in wireless communication.

II. Background

Wireless communication networks are widely deployed to provide various communication services such as voice, video, packet data, messaging, broadcast, etc. These wireless communication networks may include packet-switched networks and circuit-switched networks. Packet-switched refers to transfer of data for a user via common resources (e.g., a shared channel) that may be shared by multiple users. Circuit-switched refers to transfer of data for a user via dedicated resources (e.g., a dedicated channel) assigned to the user. A packet-switched network may support concurrent voice and data services, higher data rates, and other enhanced features but may have limited coverage. A circuit-switched network may support voice and low-rate data services but may have wide coverage.

A terminal (e.g., a cellular phone) may be capable of communicating with both packet-switched networks and circuit-switched networks. This capability may allow a user to obtain the performance advantages provided by packet-switched networks and the coverage benefits provided by circuit-switched networks. The terminal may have a voice call with a packet-switched network and may roam to a circuit-switched network. It is desirable for the terminal to maintain the voice call even as the user roams about different networks.

### SUMMARY

Techniques for supporting handoff of terminals between a packet-switched (PS) network and a circuit-switched (CS) network are described herein. The terms “handoff” and “handover” are often used interchangeably. In an aspect, inter-domain handoff between packet-switched and circuit-switched networks may be facilitated by a designated network entity in the packet-switched network. The designated network entity may interface with both the packet-switched network and the circuit-switched network, perform circuit-switched call origination, and perform handoff procedure. In one design, the designated network entity may comprise a Mobile Switching Center Emulation (MSCe) that may emulate a conventional Mobile Switching Center (MSC) for call processing. The designated network entity may allow the packet-switched network to interface with the circuit-switched networks via standardized interface and standardized procedures. This may be highly desirable for a network operator that deploys only the packet-switched network, which may then easily connect to the circuit-switched network of a roaming partner.

In one design, a first terminal may initially communicate with the packet-switched network for a packet-switched call with a second terminal. The first terminal may thereafter initiate handoff to the circuit-switched network via the designated network entity in the packet-switched network. The first terminal may perform handoff from the packet-switched network to the circuit-switched network based on an inter-MSC handoff procedure. The first terminal may then communicate with the circuit-switched network for the circuit-switched call with the second terminal after the handoff to the circuit-switched network.

In one design, the designated network entity may receive a message for handoff of the first terminal from the packet-switched network to the circuit-switched network. The designated network entity may originate the circuit-switched call for the first terminal in response to receiving the message. The designated network entity may also perform an inter-MSC handoff procedure with an MSC in the circuit-switched network to handoff the terminal to the circuit-switched network.

Various aspects and features of the disclosure are described in further detail below.

### BRIEF DESCRIPTION OF THE DRAWINGS

FIG. 1 shows a packet-switched network and a circuit-switched network.

FIG. 2 shows coverage of the packet-switched and circuit-switched networks.

FIG. 3 shows a message flow for handoff of a terminal from the packet-switched network to the circuit-switched network.

FIG. 4 shows communication after handoff to the circuit-switched network.

FIG. 5 shows a process performed by the terminal.

FIG. 6 shows a process performed by the designated network entity in the packet-switched network to support handoff.

FIG. 7 shows a block diagram of the terminal, a radio access network (RAN), and the designated network entity.

### DETAILED DESCRIPTION

The techniques described herein may be used for various wireless communication networks. The terms “network” and “system” are often used interchangeably. A wireless communication network may include a core network and RANs. A core network may include network entities defined by an organization named “3rd Generation Partnership Project” (3GPP) or an organization named “3rd Generation Partnership Project 2” (3GPP2). The network entities in a core network may support various services and functions for terminals.

A RAN may support radio communication for terminals and may also be referred to as a radio network, an access network, etc. A RAN may implement Code Division Multiple Access (CDMA), Time Division Multiple Access (TDMA), Frequency Division Multiple Access (FDMA), Orthogonal FDMA (OFDMA), Single-Carrier FDMA (SC-FDMA) or some other multiple-access techniques. A RAN may implement a CDMA radio technology such as cdma2000, Universal Terrestrial Radio Access (UTRA), etc. cdma2000 covers IS-2000, IS-95 and IS-856 standards. UTRA includes Wideband CDMA (WCDMA) and other variants of CDMA. A RAN may also implement a TDMA radio technology such as Global System for Mobile Communications (GSM). A RAN may also implement an OFDMA radio technology such as Evolved UTRA (E-UTRA), Ultra Mobile Broadband (UMB), IEEE 802.11 (Wi-Fi), IEEE 802.16 (WiMAX), IEEE 802.20, Flash-OFDM®, etc. UTRA and E-UTRA are part of Universal Mobile Telecommunication System (UMTS). 3GPP Long Term Evolution (LTE) and LTE-Advanced (LTE-A) are new releases of UMTS that use E-UTRA. UTRA, E-UTRA, UMTS, LTE, LTE-A and GSM are described in documents from 3GPP. cdma2000 and UMB are described in documents from 3GPP2.

The techniques described herein may be used for the networks and radio technologies mentioned above as well as other networks and radio technologies. For clarity, certain aspects of the techniques are described below for 3GPP2 networks, and 3GPP2 terminology is used in much of the description below. In 3GPP2, IS-2000 Releases 0 and A are commonly referred to as CDMA2000 1X, and IS-2000 Release C is commonly referred to as CDMA2000 1xEV-DV. IS-2000 networks are circuit-switched networks and are commonly referred to as 1X networks. IS-856 is commonly referred to as High Rate Packet Data (HRPD), CDMA2000 1xEV-DO, 1xEV-DO, 1x-DO, DO, High Data Rate (HDR), etc. IS-856 networks are packet-switched networks and are commonly referred to as HRPD networks.

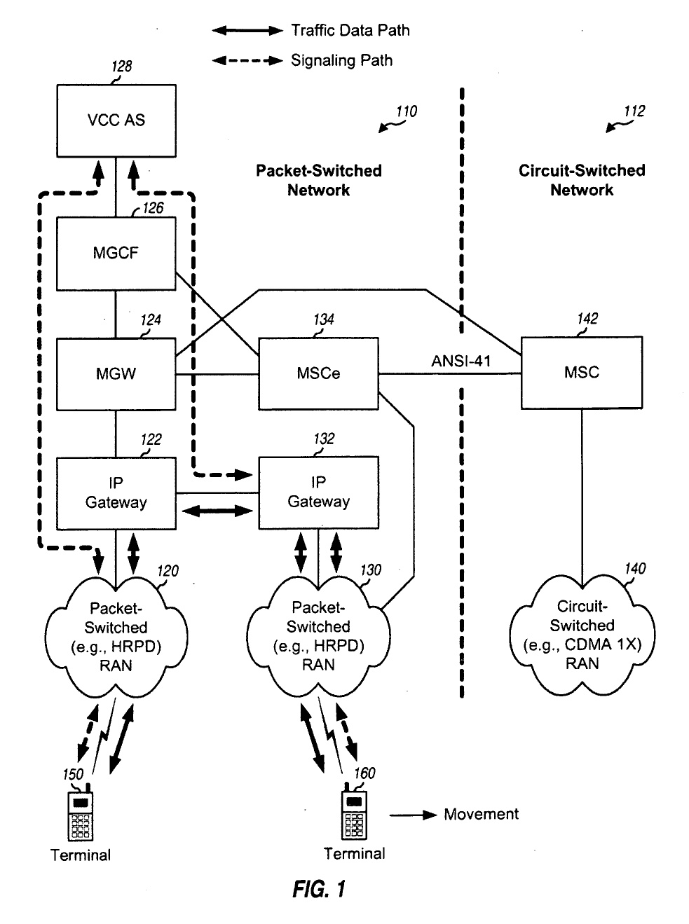

FIG. 1 shows an exemplary deployment of a packet-switched network 110 and a circuit-switched network 112 that may support communication for a number of terminals. For simplicity, only two terminals 150 and 160 are shown in FIG. 1. A terminal may be stationary or mobile and may also be referred to as a mobile station (MS), a user equipment (UE), an access terminal (AT), a subscriber unit, a station, etc. A terminal may be a cellular phone, a personal digital assistant (PDA), a wireless modem, a wireless communication device, a handheld device, a laptop computer, a cordless phone, a wireless local loop (WLL) station, etc. A terminal may communicate with a RAN for radio communication. A terminal may also communicate with other network entities to obtain various services such as voice, packet data, messaging, etc. In the exemplary design shown in FIG. 1, packet-switched network 110 includes packet-switched RANs 120 and 130, Internet Protocol (IP) gateways 122 and 132, a Media Gateway (MGW) 124, a Media Gateway Control Function (MGCF) 126, an MSCe 134, and a Voice Call Continuity Application Server (VCC AS) 128. RANs 120 and 130 may be HRPD RANs or some other packet-switched RANs. Each RAN may include base stations, Base Station Controllers (BSCs), Packet Control Functions (PCFs), and/or other network entities that support radio communication for terminals within the coverage of the RAN. IP gateways 122 and 132 may support data services for terminals communicating with RANs 120 and 130, respectively. For example, each IP gateway may be responsible for establishment, maintenance, and termination of data sessions for terminals, routing of data for the terminals, and assignment of dynamic IP addresses to the terminals.

MGW 124 and MGCF 126 may be part of an IP Multimedia Subsystem (IMS), which utilizes packet-switched domain. IMS is an architectural framework for delivering IP multimedia services such as Voice-over-IP (VoIP) to users. MGW 124 may convert digital media streams between different telecommunications networks. For example, MGW 124 may convert TDM voice data to a media streaming protocol such as Real Time Protocol (RTP) as well as a signaling protocol such as Session Initiation Protocol (SIP), which are commonly used for VoIP. MGW 124 may also convert between different coders/decoders (codecs) used by two endpoints of a call. MGCF 126 may control resources in MGW 124 and may also perform conversion between call control protocols such as SIP and ISDN User Part (ISUP).

VCC AS 128 may anchor packet-switched (e.g., IMS) and circuit-switched calls for terminals. VCC AS 128 may support voice call continuity for terminals and may provide capabilities to transfer voice calls between packet-switched domain and circuit-switched domain. VCC AS 128 may allow terminals to move between packet-switched network 110 and circuit-switched network 112 by “calling into” VCC AS 128 and moving voice calls from an old domain (e.g., packet-switched) to a new domain (e.g., circuit-switched). VCC AS 128 may also allow a terminal to be reached by a single number over circuit-switched and IMS. An incoming call for the terminal may be anchored in VCC AS 128 and may be delivered over IMS or circuit-switched depending on user registration.

MSCe 134 may interface with both packet-switched network 110 and circuit-switched network 112. For example, MSCe 134 may interface with a conventional MSC in a circuit-switched network via an ANSI-41 interface. MSCe 134 may interface with a packet-switched RAN via standardized interface (e.g., an A1p interface) or a proprietary interface. MSCe 134 may emulate a conventional MSC, provide signaling capabilities equivalent to a conventional MSC, and provide processing and control for calls and services. MSCe 134 may perform various functions for call control to facilitate handoff of terminals between packet-switched network 110 and circuit-switched network 112. For example, MSCe 134 may originate a circuit-switched call and perform an inter-MSC handoff procedure for a terminal moving from packet-switched network 110 to circuit-switched network 112. MSCe 134 may communicate with VCC AS 128 to facilitate handoff from packet-switched network 110 to circuit-switched network 112. MSCe 134 may allow packet-switched network 110 to interface with circuit-switched networks via standardized ANSI-41 interface and standardized procedures for MSCs in circuit-switched networks. This may be highly desirable since a network operator may deploy only packet-switched network 110 and no circuit-switched networks. MSCe 134 may then be used to connect packet-switched network 110 to other circuit-switched networks via the ANSI-41 interface. If MSCe 134 were not present, then packet-switched network 110 would need to connect to other circuit-switched networks via A21 or A1/A1p interface. However, the A21 and A1/A1p interfaces may not be supported by many circuit-switched networks, which may instead use proprietary interfaces to interface with packet-switched networks. Packet-switched network 110 may then be unable to connect to circuit-switched networks that do not support A21 or A1/A1p interface.

In the exemplary design shown in FIG. 1, circuit-switched network 112 includes a circuit-switched RAN 140 and an MSC 142. RAN 140 may include base stations, BSCs, and/or other network entities that support radio communication for terminals within the coverage of the RAN. MSC 142 may support circuit-switched services (e.g., voice) and may perform radio resource management, mobility management, and other functions to support communication for terminals with circuit-switched calls.

FIG. 1 shows some network entities that may be present in packet-switched network 110 and circuit-switched network 112. Each network may include different and/or other network entities not shown in FIG. 1. The network entities in FIG. 1 may also be referred to by other names and/or may be replaced by equivalent entities. For example, an IP gateway may be equivalent to a Packet Data Serving Nodes (PDSN), a Serving General Packet Radio Service (GPRS) Support Node (SGSN), a Gateway GPRS Support Node (GGSN), a Packet Data Network (PDN) Gateway, etc. An MSC may be equivalent to a Radio Network Controller (RNC), etc. The network entities in 3GPP2 are described in 3GPP2 A.S0009-A, entitled “Interoperability Specification (IOS) for High Rate Packet Data (HRPD) Radio Access Network Interfaces with Session Control in the Packet Control Function,” March 2006. The network entities in 3GPP are described in 3GPP TS 23.002, entitled “Technical Specification Group Services and Systems Aspects; Network architecture,” December 2008, and 3GPP TS 23.401, entitled “General Packet Radio Service (GPRS) enhancements for Evolved Universal Terrestrial Radio Access Network (E-UTRAN) access,” December 2008. These 3GPP and 3GPP2 documents are publicly available.

FIG. 1 also shows a traffic data path and a signaling path for a packet-switched call between terminal 150 and terminal 160. Terminal 150 may send traffic data via RAN 120, IP gateways 122 and 132, and RAN 130 to terminal 160. Terminal 150 may send signaling via RAN 120, one or more network entities, VSS AS 128, and RAN 130 to terminal 160. Signaling may be sent as IP packets, which may be forwarded by one or more network entities from RAN 120 to VCC AS 128, and from VCC AS 128 to RAN 130. The traffic data path and the signaling path from terminal 160 to terminal 150 are reverse of the traffic data path and the signaling path from terminal 150 to terminal 160.

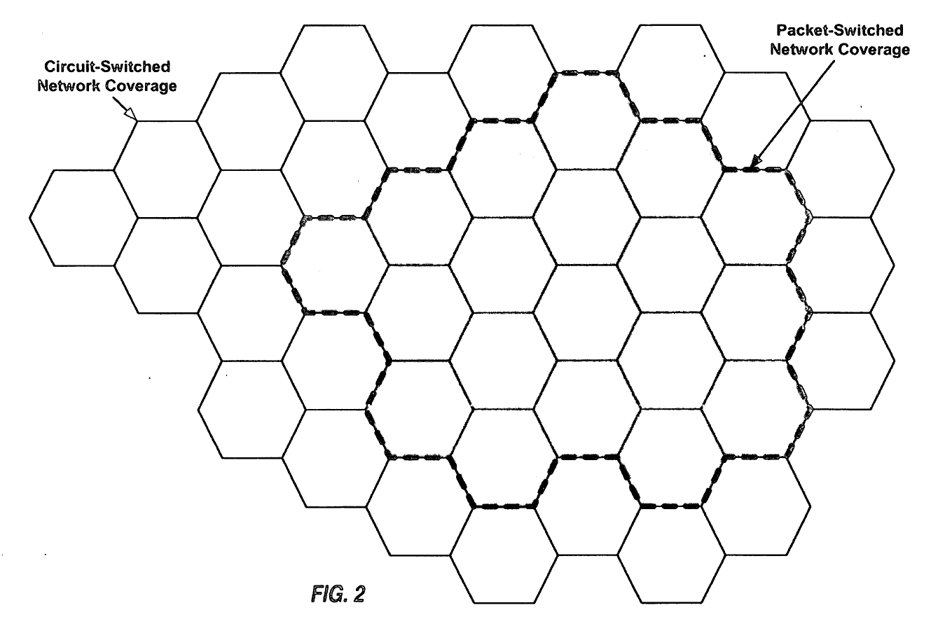

FIG. 2 shows exemplary coverage of packet-switched network 110 and circuit-switched network 112. Packet-switched network 110 may be deployed by a first network operator that may not own a circuit-switched network. Packet-switched network 110 may have limited coverage, e.g., may cover only metropolitan areas. Circuit-switched network 112 may be deployed by a second network operator that may have a roaming agreement with the first network operator. Circuit-switched network 112 may have wide coverage, which may completely overlap the coverage area of packet-switched network 110 (as shown in FIG. 2) or partially overlap the coverage area of packet-switched network 110.

It may be desirable for the first network operator to provide VCC-like services on packet-switched network 110 while minimizing changes and dependencies on the second network operator. The first network operator may achieve this by deploying MSCe 134 in packet-switched network 110. Handoffs of VCC calls from packet-switched network 110 to circuit-switched network 112 may then be achieved by performing inter-MSC handoff procedures between MSCe 134 in packet-switched network 110 and MSC 142 in circuit-switched network 112. For handoff of terminal 160 from packet-switched network 110 to circuit-switched network 112, packet-switched RAN 130 may communicate with MSCe 134. MSCe 134 may then communicate with MSC 142 to set up a circuit-switched call for terminal 160 and may initiate an inter-MSC handoff of terminal 160 to MSC 142. MSCe 134 may act as an anchor MSC for terminal 160 for the duration of the circuit-switched call. MSCe 134 may allow the first network operator to provide VCC services without having to depend on circuit-switched roaming partners, e.g., to change 1X-BSC to support A21, etc.

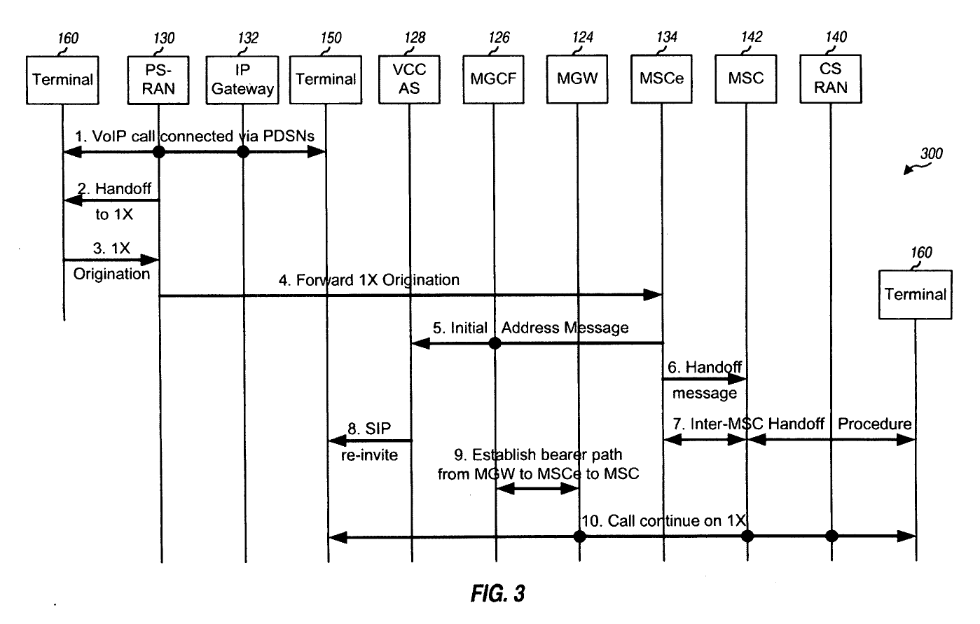

FIG. 3 shows a design of a message flow 300 for handoff of terminal 160 from packet-switched network 110 to circuit-switched network 112. Terminal 160 may initially communicate with terminal 150 via packet-switched RANs 130 and 120, respectively, for a packet-switched call (step 1). The packet-switched call may be for VoIP (or some other service) and may be established in the normal manner. The packet-switched call may be anchored in VCC AS 128, which means that signaling for the packet-switched call may be directed to VCC AS 128. For the packet-switched call, traffic data and signaling may be exchanged between terminal 150 and 160 as shown in FIG. 1. For simplicity, RAN 120 and PDSN 122 are not shown in FIG. 3.

Terminal 160 may be mobile and may periodically send pilot reports to RAN 130. RAN 130 may determine that terminal 160 is near the coverage edge of packet-switched network 110 and may inform terminal 160 of the need to perform handoff to circuit-switched network 112 (step 2). Terminal 160 may then send a 1X Origination message with an address (e.g., an E.164 number) of VCC AS 128 to RAN 130 via Circuit Services Notification Application (CSNA) (step 3). RAN 130 may forward the 1X Origination message via an A14-1x Service Transfer message to MSCe 134 (step 4). MSCe 134 may receive the message from RAN 130 and may send an Initial Address Message (IAM) via MGCF 126 to VCC AS 128 (step 5). The Initial Address Message may originate a circuit-switched call for terminal 160. MSCe 134 may also send a handoff message to MSC 142 to initiate inter-MSC handoff for the circuit-switched call (step 6). MSCe 134, MSC 142 and terminal 160 may then perform an inter-MSC handoff procedure to handoff terminal 160 to circuit-switched network 112 (step 7).

VCC AS 128 may receive the Initial Address Message from MSCe 134 and may ascertain that terminal 160 is attempting to make a circuit-switched call while a packet-switched call is pending. VCC AS 128 may then recognize that terminal 160 is attempting handoff from packet-switched network 110 to circuit-switched network 112. VCC AS 128 may send a SIP message to terminal 150 to re-invite terminal 150 to a session with MGW 124 to continue the voice call with terminal 160 (step 8). VCC AS 128 may also inform MGCF 126 to establish a session for terminals 150 and 160. MGCF 126 may communicate with MGW 124 to establish a bearer path from MGW 124 to MSC 142 (step 9). Steps 8 and 9 may occur concurrently with steps 6 and 7.

The voice call between terminals 150 and 160 may then continue via packet-switched RAN 120, MGW 124, MSC 142, and circuit-switched RAN 140 (step 10).

FIG. 3 shows an exemplary message flow for handoff of terminal 160 from packet-switched network 110 to circuit-switched network 112 using MSCe 134. The handoff may occur with different and/or other steps not shown in FIG. 3.

The handoff may allow the voice call, which was initially carried by the packet-switched call, to be seamlessly transferred to the circuit-switched call. This may provide good user experience for both terminals 150 and 160.

As shown in FIG. 3, MSCe 134 may facilitate handoff of terminal 160 from packet-switched network 110 to circuit-switched network 112. MSCe 134 may appear as a circuit-switched MSC to circuit-switched network 112, which may allow the handoff of terminal 160 to be achieved with an inter-MSC handoff procedure. MSC 142 may thus be able to perform handoff of terminal 160 in similar manner as for other circuit-switch calls. MSC 142 may not be aware that terminal 160 is being handed off from packet-switched network 110.

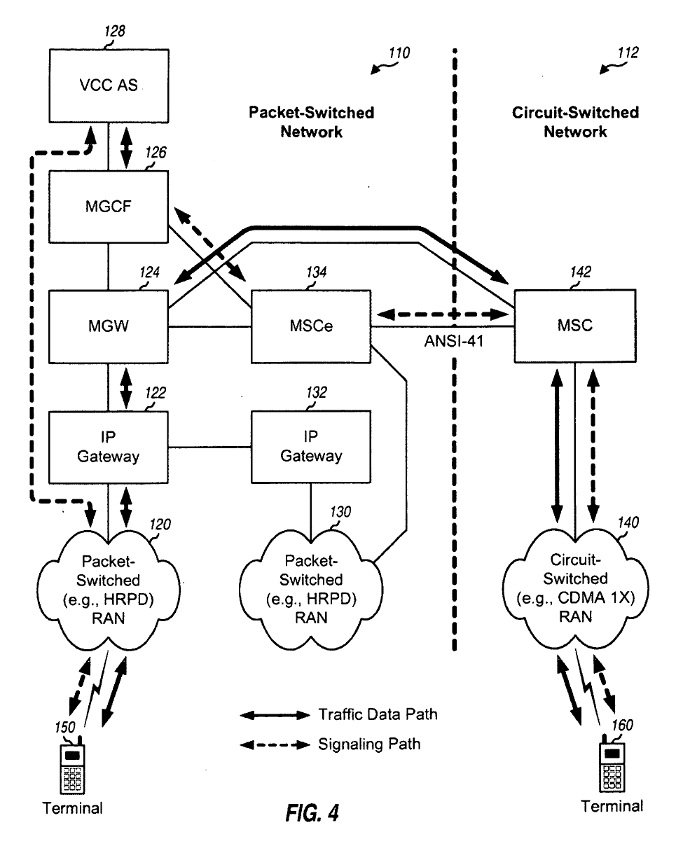

FIG. 4 shows communication between terminals 150 and 160 after handoff of terminal 160 from packet-switched network 110 to circuit-switched network 112. Terminal 160 may send traffic data via circuit-switched RAN 140, MSC 142, MGW 124, IP gateway 122, and packet-switched RAN 120 to terminal 150. Terminal 160 may send signaling via circuit-switched RAN 140, MSC 142, MSCe 134, VSS AS 128, one or more network entities, and packet-switched RAN 120 to terminal 150. The traffic data path and the signaling path from terminal 150 to terminal 160 may be reverse of the traffic data path and the signaling path from terminal 160 to terminal 150. VSS AS 128 may continue to anchor the circuit-switched call for terminal 160 after the handoff to circuit-switched network 112. MSCe 134 may facilitate exchange of signaling between terminals 150 and 160 for the circuit-switched call. MSC 142 may communicate with MSCe 134 via the ANSI-41 interface and may communicate with MGW 124 via a standardized interface.

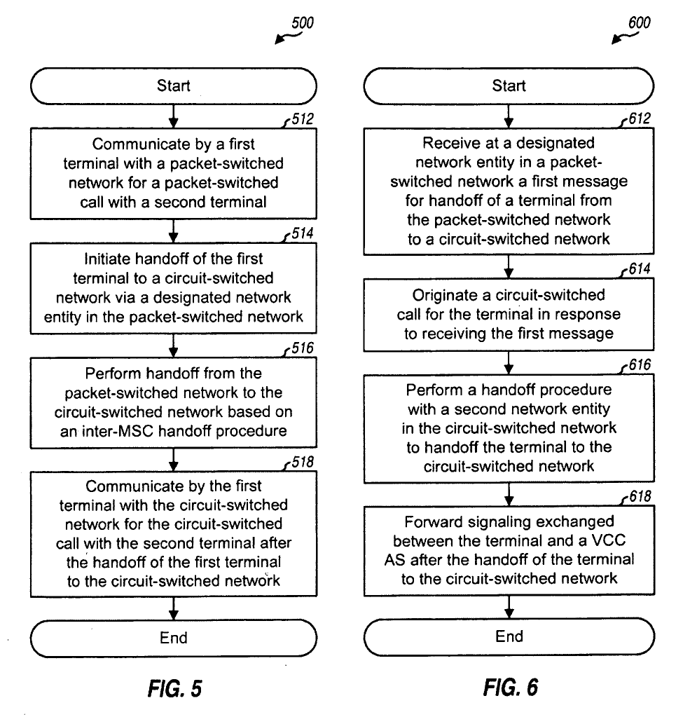

FIG. 5 shows a design of a process 500 performed by a first terminal (e.g., terminal 160 in FIG. 1) for communication. The first terminal may communicate with a packet-switched network for a packet-switched call with a second terminal (block 512). The first terminal may initiate handoff to a circuit-switched network via a designated network entity in the packet-switched network (block 514). The designated network entity may interface with both the packet-switched network and the circuit-switched network. The designated network entity may originate a circuit-switched call for the first terminal and may perform a handoff procedure for the first terminal. In one design, the designated network entity may comprise an MSCe that emulates a conventional MSC for call processing. The first terminal may perform handoff from the packet-switched network to the circuit-switched network based on an inter-MSC handoff procedure (block 516). The first terminal may then communicate with the circuit-switched network for the circuit-switched call with the second terminal after the handoff to the circuit-switched network (block 518).

The first terminal may communicate with a packet-switched RAN (e.g., an HRPD RAN) in the packet-switched network prior to the handoff. The first terminal may communicate with a circuit-switched RAN (e.g., a CDMA 1X RAN) in the circuit-switched network after the handoff. In one design of block 514, the first terminal may receive a handoff indication from the packet-switched RAN. The first terminal may then send a circuit-switched call origination message to the packet-switched RAN in response to the handoff indication. The packet-switched call for the first terminal may be anchored in a VCC AS. The first terminal may send the circuit-switched call origination message to an address of the VCC AS.

In one design of block 518, the first terminal may exchange traffic data via an MSC in the circuit-switched network and an MGW in the packet-switched network after the handoff. The first terminal may exchange signaling via the MSC in the circuit-switched network and the designated network entity in the packet-switched network after the handoff.

FIG. 6 shows a design of a process 600 performed by a designated network entity in a packet-switched network to support handoff. The designated network entity may receive a first message for handoff of a terminal from the packet-switched network to a circuit-switched network (block 612). The designated network entity may interface with both the packet-switched network and the circuit-switched network. The designated network entity may originate a circuit-switched call for the terminal in response to receiving the first message (block 614). The designated network entity may also perform a handoff procedure with a second network entity in the circuit-switched network to handoff the terminal to the circuit-switched network (block 616).

In one design of block 612, the designated network entity may receive the first message sent by the terminal to an address of a VCC AS anchoring a packet-switched call for the terminal. In one design of block 614, the designated network entity may send a second message to the VCC AS, based on the address of the VCC AS obtained from the first message, to originate the circuit-switched call for the terminal.

In one design, the designated network entity may comprise an MSCe that emulates a conventional MSC for call processing. In one design of block 616, the designated network entity may perform an inter-MSC handoff procedure with an MSC in the circuit-switched network to handoff the terminal from the packet-switched network to the circuit-switched network. The designated network entity may interface with the MSC in the circuit-switched network via the ANSI-41 interface. The designated network entity may interface with a packet-switched RAN via a standardized interface or a proprietary interface. The designated network entity may forward signaling exchanged between the terminal and the VCC AS after the handoff of the terminal to the circuit-switched network (block 618).

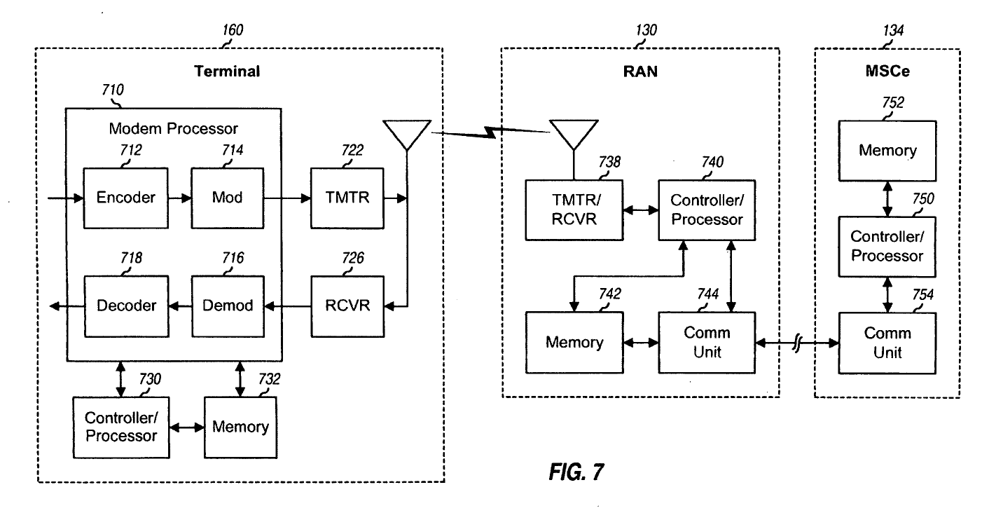

FIG. 7 shows a block diagram of a design of terminal 160, RAN 130, and MSCe 134 in FIG. 1. At terminal 160, an encoder 712 may receive traffic data and signaling (e.g., messages for handoff) to be sent by terminal 160 on the reverse link. Encoder 712 may process (e.g., encode and interleave) the traffic data and signaling. A modulator (Mod) 714 may further process (e.g., modulate, channelize, and scramble) the encoded data and signaling and provide output samples. A transmitter (TMTR) 722 may condition (e.g., convert to analog, filter, amplify, and frequency upconvert) the output samples and generate a reverse link signal, which may be transmitted to RAN 130.

On the forward link, terminal 160 may receive a forward link signal from RAN 130. A receiver (RCVR) 726 may condition (e.g., filter, amplify, frequency downconvert, and digitize) a received signal and provide input samples. A demodulator (Demod) 716 may process (e.g., descramble, channelize, and demodulate) the input samples and provide symbol estimates. A decoder 718 may process (e.g., deinterleave and decode) the symbol estimates and provide decoded data and signaling sent to terminal 160. Encoder 712, modulator 714, demodulator 716 and decoder 718 may be implemented by a modem processor 710. These units may perform processing in accordance with the radio technology (e.g., HRPD, CDMA 1X, WCDMA, LTE, etc.) used by the RAN. A controller/processor 730 may direct the operation of various units at terminal 160.

Processor 730 and/or other units at terminal 160 may perform or direct process 500 in FIG. 5, and/or other processes for the techniques described herein. Memory 732 may store program codes and data for terminal 160.

At RAN 130, a transmitter/receiver 738 may support radio communication for terminal 160 and other terminals. A controller/processor 740 may perform various functions for communication with the terminals. For the reverse link, the reverse link signal from terminal 160 may be received and conditioned by receiver 738 and further processed by controller/processor 740 to recover the traffic data and signaling sent by the terminal. For the forward link, traffic data and signaling may be processed by controller/processor 740 and conditioned by transmitter 738 to generate a forward link signal, which may be transmitted to terminal 160 and other terminals. Memory 742 may store program codes and data for the RAN. A communication (Comm) unit 744 may support communication with other network entities.

At MSCe 134, a controller/processor 750 may perform various functions to support handoff of terminals between packet-switched network 110 and circuit-switched network 112. Processor 750 and/or other units at MSCe 134 may perform process 600 in FIG. 6, and/or other processes for the techniques described herein. Memory 752 may store program codes and data for MSCe 134. A communication unit 754 may support communication with other network entities.

FIG. 7 shows a simplified block diagram of some entities in FIG. 1. Although not shown in FIG. 7 for simplicity, other RANs and network entities in FIG. 1 may also be implemented in similar manner. In general, each entity may include any number of processors, controllers, memories, transmitters/receivers, communication units, etc.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the disclosure herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the disclosure herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary designs, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

What is claimed is:

1. A method for wireless communication, comprising:
communicating by a first terminal with a packet-switched network for a packet-switched call with a second terminal;
initiating handoff of the first terminal to a circuit-switched network via a designated network entity in the packet-switched network, the designated network entity interfacing with both the packet-switched network and the circuit-switched network, originating a circuit-switched call for the first terminal, and performing a handoff procedure for the first terminal; and
communicating by the first terminal with the circuit-switched network for the circuit-switched call with the second terminal after the handoff of the first terminal to the circuit-switched network.

2. The method of claim 1, further comprising:
communicating with a packet-switched radio access network (RAN) in the packet-switched network prior to the handoff; and
communicating with a circuit-switched RAN in the circuit-switched network after the handoff.

3. The method of claim 2, wherein the initiating handoff of the first terminal comprises
receiving a handoff indication from the packet-switched RAN, and
sending a circuit-switched call origination message to the packet-switched RAN in response to the handoff indication.

4. The method of claim 3, wherein the packet-switched call for the first terminal is anchored in a Voice Call Continuity Application Server (VCC AS), and wherein the circuit-switched call origination message is sent to an address of the VCC AS.

5. The method of claim 1, wherein the designated network entity comprises a Mobile Switching Center Emulation (MSCe) emulating a Mobile Switching Center (MSC) for call processing, the method further comprising:
performing handoff from the packet-switched network to the circuit-switched network based on an inter-MSC handoff procedure.

6. The method of claim 1, wherein the communicating with the circuit-switched network comprises
exchanging traffic data via a Mobile Switching Center (MSC) in the circuit-switched network and a Media Gateway (MGW) in the packet-switched network after the handoff, and
exchanging signaling via the MSC in the circuit-switched network and the designated network entity in the packet-switched network after the handoff.

7. The method of claim 2, wherein the packet-switched RAN comprises a High Rate Packet Data (HRPD) RAN, and wherein the circuit-switched RAN comprises a CDMA 1X RAN.

8. An apparatus for wireless communication, comprising:
means for communicating by a first terminal with a packet-switched network for a packet-switched call with a second terminal;
means for initiating handoff of the first terminal to a circuit-switched network via a designated network entity in the packet-switched network, the designated network entity interfacing with both the packet-switched network and the circuit-switched network, originating a circuit-switched call for the first terminal, and performing a handoff procedure for the first terminal; and
means for communicating by the first terminal with the circuit-switched network for the circuit-switched call with the second terminal after the handoff of the first terminal to the circuit-switched network.

9. The apparatus of claim 8, wherein the means for initiating handoff of the first terminal comprises
means for receiving a handoff indication from a packet-switched radio access network (RAN), and
means for sending a circuit-switched call origination message to the packet-switched RAN in response to the handoff indication.

10. The apparatus of claim 8, wherein the designated network entity comprises a Mobile Switching Center Emulation (MSCe) emulating a Mobile Switching Center (MSC) for call processing, the apparatus further comprising:
means for performing handoff from the packet-switched network to the circuit-switched network based on an inter-MSC handoff procedure.

11. The apparatus of claim 8, wherein the means for communicating with the circuit-switched network comprises
means for exchanging traffic data via a Mobile Switching Center (MSC) in the circuit-switched network and a Media Gateway (MGW) in the packet-switched network after the handoff, and
means for exchanging signaling via the MSC in the circuit-switched network and the designated network entity in the packet-switched network after the handoff.

12. An apparatus for wireless communication, comprising:
at least one processor configured to communicate by a first terminal with a packet-switched network for a packet-switched call with a second terminal, to initiate handoff of the first terminal to a circuit-switched network via a designated network entity in the packet-switched network, the designated network entity interfacing with both the packet-switched network and the circuit-switched network, originating a circuit-switched call for the first terminal, and performing a handoff procedure for the first terminal, and to communicate by the first terminal with the circuit-switched network for the circuit-switched call with the second terminal after the handoff of the first terminal to the circuit-switched network.

13. The apparatus of claim 12, wherein the at least one processor is configured to receive a handoff indication from a packet-switched radio access network (RAN), and to send a circuit-switched call origination message to the packet-switched RAN in response to the handoff indication.

14. The apparatus of claim 12, wherein the designated network entity comprises a Mobile Switching Center Emulation (MSCe) emulating a Mobile Switching Center (MSC) for call processing, and wherein the at least one processor is configured to perform handoff from the packet-switched network to the circuit-switched network based on an inter-MSC handoff procedure.

15. The apparatus of claim 12, wherein the at least one processor is configured to exchange traffic data via a Mobile Switching Center (MSC) in the circuit-switched network and a Media Gateway (MGW) in the packet-switched network after the handoff, and to exchange signaling via the MSC in the circuit-switched network and the designated network entity in the packet-switched network after the handoff.

16. A computer program product, comprising:
a computer-readable medium comprising:
code for causing at least one computer to communicate by a first terminal with a packet-switched network for a packet-switched call with a second terminal,
code for causing the at least one computer to initiate handoff of the first terminal to a circuit-switched network via a designated network entity in the packet-switched network, the designated network entity interfacing with both the packet-switched network and the circuit-switched network, originating a circuit-switched call for the first terminal, and performing a handoff procedure for the first terminal, and
code for causing the at least one computer to communicate by the first terminal with the circuit-switched network for the circuit-switched call with the second terminal after the handoff of the first terminal to the circuit-switched network.

17. A method of supporting handoff for wireless communication, comprising:
receiving at a designated network entity in a packet-switched network a first message for handoff of a terminal from the packet-switched network to a circuit-switched network, the designated network entity interfacing with both the packet-switched network and the circuit-switched network;
originating a circuit-switched call for the terminal in response to receiving the first message; and
performing a handoff procedure with a second network entity in the circuit-switched network to handoff the terminal to the circuit-switched network.

18. The method of claim 17, wherein the designated network entity comprises a Mobile Switching Center Emulation (MSCe) emulating a Mobile Switching Center (MSC) for call processing, and wherein the performing a handoff procedure comprises performing an inter-MSC handoff procedure with an MSC in the circuit-switched network to handoff the terminal from the packet-switched network to the circuit-switched network.

19. The method of claim 18, further comprising:
interfacing with the MSC in the circuit-switched network via an ANSI-41 interface.

20. The method of claim 17, wherein the originating the circuit-switched call for the terminal comprises sending a second message from the designated network entity to a Voice Call Continuity Application Server (VCC AS) to originate the circuit-switched call for the terminal.

21. The method of claim 20, wherein the receiving the first message comprises receiving the first message sent by the terminal to an address of the VCC AS, and wherein the sending the second message comprises sending the second message to the VCC AS based on the address of the VCC AS in the first message.

22. The method of claim 20, further comprising:
forwarding signaling exchanged between the terminal and the VCC AS after the handoff of the terminal to the circuit-switched network.

23. An apparatus supporting handoff for wireless communication, comprising:
means for receiving at a designated network entity in a packet-switched network a first message for handoff of a terminal from the packet-switched network to a circuit-switched network, the designated network entity interfacing with both the packet-switched network and the circuit-switched network;
means for originating a circuit-switched call for the terminal in response to receiving the first message; and
means for performing a handoff procedure with a second network entity in the circuit-switched network to handoff the terminal to the circuit-switched network.

24. The apparatus of claim 23, wherein the designated network entity comprises a Mobile Switching Center Emulation (MSCe) emulating a Mobile Switching Center (MSC) for call processing, and wherein the means for performing a handoff procedure comprises means for performing an inter-MSC handoff procedure with an MSC in the circuit-switched network to handoff the terminal from the packet-switched network to the circuit-switched network.

25. The apparatus of claim 23, wherein the means for receiving the first message comprises means for receiving the first message sent by the terminal to an address of a Voice Call Continuity Application Server (VCC AS), and wherein the means for originating the circuit-switched call for the terminal comprises means for sending a second message from the designated network entity to the VCC AS, based on the address of the VCC AS in the first message, to originate the circuit-switched call for the terminal.

26. The apparatus of claim 25, further comprising:
means for forwarding signaling exchanged between the terminal and the VCC AS after the handoff of the terminal to the circuit-switched network.
